(19) United States
(12) Patent Application Publication
(10) Pub. No.: US 2007/0275479 A1
(43) Pub. Date: Nov. 29, 2007

(54) Method and materials for measuring the leachability of metals

(76) Inventor: Dileep Chintaman Joshi, Oklahoma City, OK (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/438,880

(22) Filed: May 23, 2006

(51) Int. Cl. G01N 1/18

(52) U.S. Cl. 436/178

(57) ABSTRACT

The accelerated testing of articles for the leachability of metals into a fluid stream is accomplished by contacting the article with an extraction solution, ultrasonically agitating the solution with optional heating, and analyzing the solution for the presence of extracted metals. A particular extraction solution for assessing the extractability of metals into drinking water includes bicarbonate and a free halogen.

### FIELD OF THE INVENTION

This invention relates generally to testing methods and reagents for assessing the leachability of particular metals from articles of manufacture. More specifically, the invention relates to methods and materials for the accelerated testing of the leachability of particular metals from plumbing fixtures into drinking water.

### BACKGROUND OF THE INVENTION

The presence of inappropriate levels of particular metals in water used for drinking, cooking, food preparation and the like has been shown to have an adverse effect on humans and other species. Likewise, the presence of undesirable levels of certain metals in water can interfere with various industrial processes.

Leaching of metals from fixtures, devices, fittings and other components of plumbing systems can be a significant source of metal contamination in the water supply. As a consequence, various agencies have established standards for the permissible levels of leachability of metals from such articles. For example, the National Sanitary Foundation has established a standard referred to as NSF/ANSI Standard 61. This standard establishes minimum requirements for the amounts of metals that can leach from articles used in drinking water systems. This standard covers a large variety of products including piping, fittings, coatings and barrier materials as well as devices such as faucets, drinking fountains and components. Certification of products under NSF-61 mandates a leachability test which requires at least nineteen days to complete. As a consequence, this test consumes significant resources in terms of space, time and cost. Furthermore, the long test time precludes the use of the NSF-61 leachability test as a regular process control test.

As will be appreciated, there is a need for a rapid, simple to implement test which can assess, accurately, the leachability of metals of interest such as lead, copper, zinc, nickel, and chromium from articles in drinking water systems. Furthermore, results of any such test should be correlatable with, and reasonably predictive of, results which would be obtained utilizing long term leachability tests such as the test procedure established under NSF-61.

U.S. Pat. No. 5,612,224 describes a test for assessing the amount of lead present on the surface of a brass component. The method is asserted to provide data correlatable with data obtained by the NSF-61 method. The procedure of the U.S. Pat. No. 5,612,224 involves a controlled etching process wherein an acid such as methane sulfonic acid is contacted with a brass surface for a period of time sufficient to etch surface lead from the brass article. The etching process is terminated before significant amounts of zinc and copper are removed, so that subsurface lead is not etched. This method requires the use of a relatively strong acid, is difficult to control, and consequently is of limited utility.

As will be explained in detail hereinbelow, the present invention provides a rapid, simple and reliable test for the leachability of metals. The test utilizes mild chemical solutions, and the results obtained through the use of the test of the present invention correlate very well with results obtained utilizing the method of NSF-61. As a consequence, the test of the present invention may be incorporated into manufacturing test protocols. While the method of the present invention is described generally, with reference to its use in assessing the leachability of metals into drinking water, the principles of the present invention may be incorporated into any other tests of metal leachability as will be further explained hereinbelow.

### BRIEF DESCRIPTION OF THE INVENTION

Disclosed herein is a method for the accelerated testing of articles to determine the leachability of at least one metal therefrom. According to the method, a leachate extraction solution is contacted with at least one surface of the article being tested. The extraction solution in contact with the surface is subjected to an input of ultrasonic energy for a period of time and thereafter the extraction solution is analyzed so as to determine the presence and/or the amount of the at least one metal therein. In a specific instance, the extraction solution is an aqueous solution of bicarbonate ions further including a free halogen therein. The pH of the solution is in the range of 8-8.5. In a specific instance, the aqueous solution is approximately 0.01 M with regard to the bicarbonate, and the free halogen comprises chlorine in an amount of 2-2.5 mg/L.

In some instances, the solution is heated while it is being ultrasonically agitated, and such heating may be to a temperature in the range of 30-90° C. In specific instances, the ultrasonic energy is input to the solution for a period of time ranging from 30-120 minutes. The extraction solution may be analyzed for the presence and/or amount of metals by processes such as inductively coupled plasma-atomic emission spectroscopy. Some of the metals which may be analyzed according to this method include Pb, Cu, Zn, Ni, and Cr, among others. Also disclosed herein are reagents for carrying out the method.

### DETAILED DESCRIPTION OF THE INVENTION

The present invention provides an accelerated method for testing articles to determine the leachability of metals therefrom. The method is advantageously employed for the testing of components of drinking water handling systems, and in that regard results obtained by the method of the present invention correlate very well with, and predict, results which are obtained by the relatively slow process of the NSF-61 method. The methodology of the present invention utilizes ultrasonic energy, and optionally heat, to accelerate metal leaching under realistic conditions simulative of use.

A specific extraction solution used in the present invention comprises a relatively mild composition having a slightly alkaline pH of 8.0-8.5. The solution includes bicarbonate ion, generally in the form of sodium bicarbonate, in an amount sufficient to make the solution 0.01 M with regard to the bicarbonate. The solution also includes relatively small amounts of a free halogen which, in specific instances, is chlorine. The free halogen is generally present in an amount of approximately 2-2.5 mg/L.

In a typical assay, the article being tested is prewashed with tap and/or distilled water to remove any particulate matter or surface contaminants. Those surfaces of the article which contact a water stream in use are then placed in contact with the extraction solution. This may be accomplished by filling the article with the solution. Contact with the solution is maintained for a period of time which is typically 30-120 minutes, and in particular instances the contact time is 1 hour. During the time the article is in contact with the extraction solution, ultrasonic energy is input to the solution, and the solution is preferably heated to a temperature below boiling, and generally in the range of 30-90° C.

Typically, the assay is carried out in parallel, on three identical parts taken from the same batch. Results from the parts are compared and data is evaluated to confirm the precision of the procedure. In some instances, the assay may be carried out on a single part, and in other instances, a larger number of parts may be assayed.

Following the completion of this extraction procedure, the ultrasonic energy input is terminated, and the extraction solution is preferably separated from the article being tested. The solution is then analyzed to verify the presence of, and optionally the amount of, metals of interest therein. Analysis may be carried out by various methods known in the art including spectroscopic methods, potentiometric methods, coulometric methods, wet chemical analyses and the like.

In one instance, it has been found that inductively coupled plasma-atomic emission spectroscopy (ICP) may be utilized to provide rapid and accurate determinations of relatively small amounts of metals in the extraction solution. As is known in the art, sample preparation for this method may include acidification of the extract. Procedures for ICP analyses are well known and documented, and in general the method involves introducing a sample into a plasma of an inert gas such as argon, wherein atoms of a metallic species in the sample are excited so as to cause photoemission, which emission is then analyzed by spectrophotometric methods. Other emission and absorption spectrophotometric methods may be similarly implemented, and as noted above other techniques such as cyclic voltammetry can be utilized. Additionally, one of skill in the art could readily implement yet other analytical methods for the practice of the present invention.

The present invention will be described with reference to one particular method for assaying plumbing fixtures such as faucets and the like for leachable metals. According to this method, an extraction solution is first prepared. This solution is formulated utilizing distilled, deionized, ICP grade water. Sodium bicarbonate is added to the water in an amount sufficient to make a 0.4 M stock solution, and in this regard 33.6 grams of sodium bicarbonate is added to a 1 L Class A volumetric flask which is filled to the measuring line with distilled, deionized, ICP grade water. 100 ml of this stock solution is further diluted with distilled, deionized, ICP water to a final volume of 4 liters, so as to produce a solution which is 0.01 M with regard to sodium bicarbonate.

Fifty microliters of a 10% solution of sodium hypochlorite is then added to the 4 liters of the aforementioned 0.01 M sodium bicarbonate solution. The solution is gently mixed and tested for free chlorine. This can be done utilizing a Hach test kit, although other test methods could also be employed. The test is carried out on portions of the sample, and adjustments made by adding subsequent portions of sodium hypochlorite until the free chlorine level in the solution is in the range of 2.0-2.5 mg/L. The pH of the resultant fluid is then measured and adjusted as necessary with 10 microliter increments of high purity hydrochloric acid until a pH in the range of 8.0-8.5 is reached. The thus prepared leachate extraction fluid may be used immediately or may be stored at 25-35° C. for up to 5 days. This procedure may be scaled up to produce larger volumes of the extraction fluid.

In subsequent steps, the articles being tested are flushed with city water for 15 minutes. Thereafter, the articles are flushed with deionized (DI) water. In this regard, the interior volume of each article being tested, such as a faucet or the like, is filled with DI water, drained, and the process repeated two additional times. The purpose of this flush is to remove any carbonates or other materials which may have been introduced by the city water flush.

Subsequently, the articles are flushed with three volumes of extraction solution following the protocol used for the DI water. This procedure dissolves any loose soluble material. Thereafter, each article is filled once more with the extraction solution and sealed. Care is taken to avoid the presence of any air pockets. Sealing may be accomplished by the use of metal-free plastic caps, stoppers and the like, and these are preferably washed with an acid such as nitric acid and rinsed in DI water prior to use.

Once the articles are filled with the extraction solution, the extraction reaction is accelerated using temperature and ultrasound. Specifically, the filled, sealed article is placed in an ultrasonic bath maintained at a temperature of 60° C. and is agitated for 60 minutes. A typical extraction procedure is carried out on three faucets having an aggregate weight of 2.4 kg, and power levels can range from 250 to 500 watts (100-200±10% watts per kilogram of sample is typical), and frequencies are in the range of 28 kHz to 45 kHz±5%. Thereafter, the extraction solution is removed for analysis. Typically, the solution is acidified to a level of 1% by volume with concentrated reagent grade nitric acid. Typically, the acidified extraction solution will have a pH in the range of 2.0 to 6.0.

Samples thus taken are analyzed in accord with conventional procedures by ICP spectroscopy. Such analysis typically detects levels of metals with a minimum precision of 0.001 mg/L, and conventionally the analysis is carried out for metals which impact, or are otherwise associated with the manufacturing process. These include lead, copper, zinc, nickel and chromium. Other metals which can easily be detected by this methodology include tin, arsenic, mercury, antimony, beryllium, barium, titanium and the like. Parallel analyses carried out on samples from the same batch by the methods of NSF-61 produce results which correlate and are scalable with those obtained by the method of the present invention. As will be appreciated, this method provides a low cost, high speed alternative to the NSF-61 method, and as such may be utilized to monitor and control the production process.

While the present invention has been described with reference to its use in measuring the leachability of metals into a water stream, it is to be understood that this invention may likewise be adapted to measure the leachability of materials into other liquids such as aqueous and nonaqueous chemical process streams. For example, the use of ultrasonic energy and an appropriate extraction reagent may be employed to assess the leachability of metals into fluid streams such as food or beverage products, as well as into other chemical compositions such as paints, lubricants and industrial fluids. The methodology may be used in connection with organic materials also. For example, leachability of preservatives such as metals and/or creosote from wood may be determined using organic based as well as aqueous extraction solutions. Such modifications and variations will be readily apparent to those of skill in the art in view of the teaching presented herein. The foregoing discussion and description is illustrative of specific embodiments of the invention, but is not meant to be a limitation upon the practice thereof. It is the following claims, including all equivalents, which define the scope of the invention.

1. A method for the accelerated testing of articles to determine the leachability of at least one species therefrom, said method comprising the steps of:
providing a leachate extraction solution;
contacting at least one surface of said article with said extraction solution;
subjecting said extraction solution which is in contact with said at least one surface to an input of ultrasonic energy for a predetermined period of time; and
analyzing said extraction solution after said predetermined period of time so as to determine the presence and/or amount of said at least one species therein.

2. The method of claim 1, wherein said at least one species is a metal and extraction solution comprises an aqueous solution having bicarbonate ions dissolved therein.

3. The method of claim 2, wherein said solution further includes a halogen.

4. The method of claim 2, wherein the pH of said solution is in the range of 8-8.5.

5. The method of claim 1, wherein said extraction solution comprises a 0.01 M solution of bicarbonate ion, said solution further including 2-2.5 mg/L of free chlorine, said solution having a pH in the range of 8-8.5.

6. The method of claim 1, further including heating said extraction solution to a temperature in the range of 30-90° C. during said predetermined period of time.

7. The method of claim 6, wherein said extraction solution is heated to a temperature of approximately 60° C.

8. The method of claim 1, wherein said at least one species comprises a member selected from the group consisting of: Pb, Cu, Zn, Ni, Cr, and combinations thereof.

9. The method of claim 1, wherein said predetermined period of time is in the range of 30-120 minutes.

10. The method of claim 1, wherein said ultrasonic energy has a power in the range of 100-200 watts±10% per kilogram of said article, and a frequency in the range of 28-45 kHz.

11. The method of claim 1, including the further step of washing said article with water prior to the step of contacting said at least one surface of said article with the extraction solution.

12. The method of claim 1, including the further step of separating said article from said extraction solution prior to the step of analyzing said extraction solution.

13. The method of claim 1, including the further step of acidifying said extraction solution after said predetermined period of time, and before said step of analyzing said extraction solution.

14. The method of claim 13, wherein said step of acidifying said extraction solution comprises acidifying said extraction solution to a pH in the range of 2.0-6.0.

15. The method of claim 1, wherein said step of analyzing said extraction solution comprises analyzing said solution by the method of inductively coupled plasma-atomic emission spectroscopy.

16. A method for the accelerated testing of a plumbing fixture to determine the leachability of at least one metal component therefrom, said method comprising the steps of:
providing a leachate extraction solution, said extraction solution comprising an aqueous solution which is 0.01 M with regard to bicarbonate ion, said solution further including 2-2.5 mg/L of free chlorine, said solution having a pH in the range of 8-8.5;
washing those surfaces of the plumbing fixture, which come in contact with water in the intended use of the fixture, with water;
contacting said surfaces with said extraction solution;
subjecting said extraction solution which is in contact with said surfaces to an input of ultrasonic energy for a period of time in the range of 30-120 minutes, while maintaining said solution at a temperature in the range of 30-90° C.;
terminating the input of ultrasonic energy to said extraction solution; and
analyzing said extraction solution so as to determine the presence and/or amount of said at least one metal therein.

17. The method of claim 16, wherein the step of analyzing said extraction solution comprises analyzing said extraction solution to determine the amount of lead therein.
